(19) United States
(12) Patent Application Publication
(10) Pub. No.: US 2013/0303954 A1
(43) Pub. Date: Nov. 14, 2013

(54) Oral Hygiene System

(71) Applicants: Winston Zhang, (US); Kurt Keller, (US); Mary Zhang, (US)

(72) Inventors: Winston Zhang, (US); Kurt Keller, (US); Mary Zhang, (US)

(21) Appl. No.: 13/945,036

(22) Filed: Jul. 18, 2013

(51) Int. Cl. A61C 17/02

(52) U.S. Cl. CPC A61C 17/02; A61C 17/0214; A61C 17/0202
USPC 601/161; 601/165; 601/162

(57) ABSTRACT

Build-in and portable oral hygiene systems and devices are disclosed which systems and devices effectively function without electricity, batteries, mechanical pumps and motors. Build-in oral hygiene systems may utilize a single set of hot and cold water supply hoses and may be integrated with the faucet as a permanent sink apparatus while portable hygiene devices are manpowered and thus may be used at anytime and anywhere.

### FIELD OF INVENTION

The field of the invention is oral hygiene methods and devices.

### BACKGROUND OF THE INVENTION

A significant public health problem: one out of every two American adults aged 30 and over has periodontal disease, according to August 2012 released findings from the Centers for Disease Control and Prevention (CDC). Some of developing countries have more than 90% of adults have periodontal disease. Periodontal disease is a chronic inflammatory disease that affects the gum tissue, bone supporting the teeth and tooth loss. Periodontal disease is associated with other chronic inflammatory diseases, such as diabetes and cardiovascular disease. Although brushing and flossing are the primary methods for oral clean, but brush and floss remove up to 70% plaque according to Sunstar Suisse S.A.

Oral irrigators especially a water jet system could remove most of plaque. USC study finds dental water jet removes 99.9 percent of dental plaque biofilm. This was released at February 2009 from University of Southern California School of Dentistry.

Various water irrigating oral hygiene devices have been in the market or have had patent proposals. For example, Water Pik from Water Pik, Inc. needs to use electricity or battery for power. Alexander, U.S. Pat. No. 8,012,111, proposed a sink fixture have a flexible tubing 175 for hot and cold water and temperature control 120. They are extras to the adjacent faucet, not only more costly to manufacture and maintain but also makes housing 110 heavy to hold. The present invention satisfies the shortcomings, limitations or disadvantages of all water irrigating oral hygiene devices in the market and patent proposals in the prior art.

### Cross Reference

U.S. Patent Documents

| | | |
|---|---|---|
| 6,056,710 | May 2000 | Bachman |
| 6,740,053 | May 2004 | Kaplowitz |
| 6,783,364 | August 2004 | Juan |
| 6,835,181 | December 2004 | Hippensteel |
| 2007/0203439 | August 2007 | Boyd et al. |
| 2007/0261163 | November 2007 | Lynam |
| 2004/0045107 | March 2004 | Egeresi |
| 2006/0010624 | January 2006 | Cleland |
| 2006/0048791 | March 2006 | Mehes et al. |
| 2008/0078021 | April 2008 | Welch |
| 2009/0053672 | February 2009 | Cornelius |
| 8,012,111 | September 2011 | Alexander |
| 8,114,038 | February 2012 | Stelmach |
| 8,449,295 | May 2013 | Hegemann |

### SUMMARY OF THE INVENTION

The present invention comprises an oral hygiene system which is fed from a single set of hot and cold water supply hoses that are coupled to a lever mixer valve that controls water temperature of water flowing to a hygiene-ware. In one embodiment, the present invention includes a switcher unit that functions to control the flow of liquid between a faucet and the hygiene-ware.

The oral hygiene system according the present invention may generate water jet without electricity, batteries which make it “green” and environment friendly.

The oral hygiene system according the present invention may generate a pulsating water jet beam or a twister water jet. The swirling pressurized water can do deep dental cleaning even in the periodontal pocket.

The oral hygiene system in one embodiment is preferably integrated with a faucet as permanent apparatus in a house . In another embodiment, the oral hygiene system is portable is powered manually by a user of the system.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is schematic of a built-in oral hygiene system.

FIG. 1a is an exploded view showing detail of a manual switcher unit.

FIG. 1b is a schematic showing a hygiene-ware.

FIG. 2 is schematic of a built-in oral hygiene system with an automatic switcher unit.

FIG. 2a depicts an automatic switcher unit.

FIG. 3 depicts some functional headers for a hygiene-ware.

FIG. 3a is an exploded view showing details of one of the functional headers.

FIG. 4 is a schematic showing an embodiment of a portable oral hygiene system ready to use.

FIG. 4a depicts a cross section of portion of the portable oral hygiene system.

FIG. 4b a schematic showing is an embodiment of the portable oral hygiene system which is achieved.

FIG. 5 is a schematic showing an embodiment of a portable oral hygiene system.

FIG. 5a depicts a cross section of a portion of the portable oral hygiene system.

### DESCRIPTION OF THE PREFERRED EMBODIMENTS

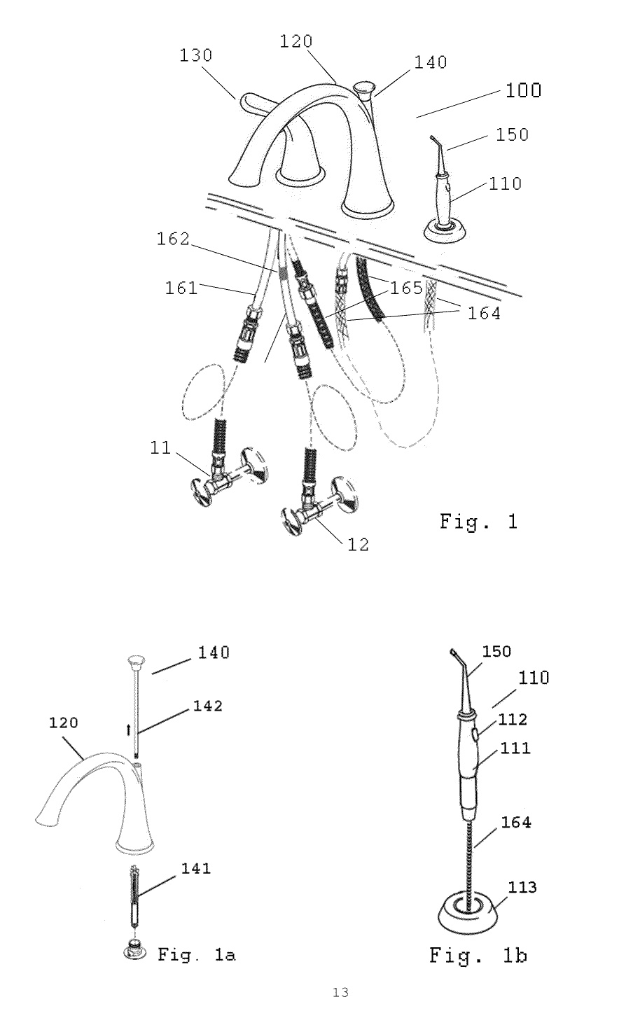

With reference to FIG. 1, a preferred build-in oral hygiene system 100 generally comprises a hygiene-ware 110, a faucet 120, lever mixer valve or temperature control 130 and a switcher unit 140. Below-counter components may be a set of hot and cold water supply hoses 161 and 162, a mixed water hose 165, and a hygiene-ware hose 164. 11 and 12 are the hot and cold water sources.

Faucet 120 may be any type of household faucet outlet that receives a mixed water hose 165 and is capable of directing the mixed water to a hygiene-ware hose 164. In the embodiment depicted in FIG. 1, the faucet 120 is configured to operate with switcher unit 140.

The switcher unit can be automatically or manually operated. FIG. 1a depicts a portion of an oral hygiene system 100 showing detail of a manually operated switcher unit 140-142. It is contemplated that a user of an oral hygiene system may manually raise and lower the handle 142 to alternate the flow of water through the faucet 120 or to the hygiene-ware 110.

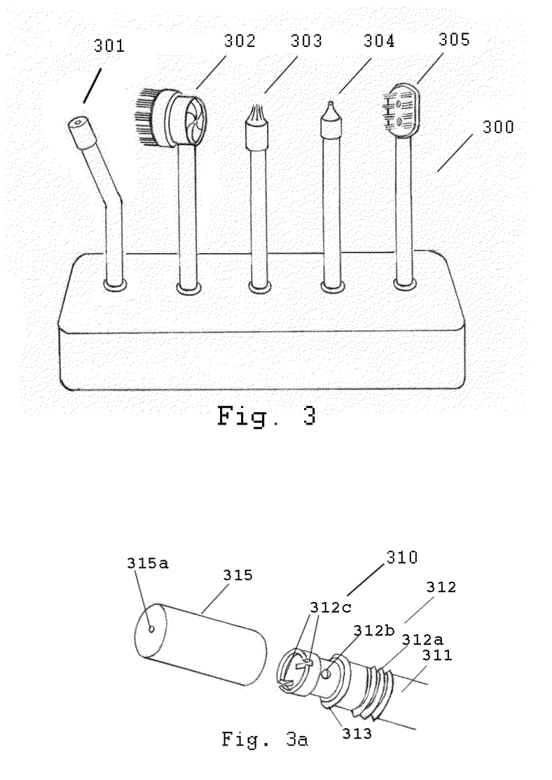

Additional detail of hygiene-ware of an oral hygiene system 100 is depicted in FIG. 1b. The hygiene-ware 110 includes a functional header 150 which is one of the functional headers depicted in FIG. 3, on/off switch 112 with value control options on handle 111; a hygiene-ware seat 113.

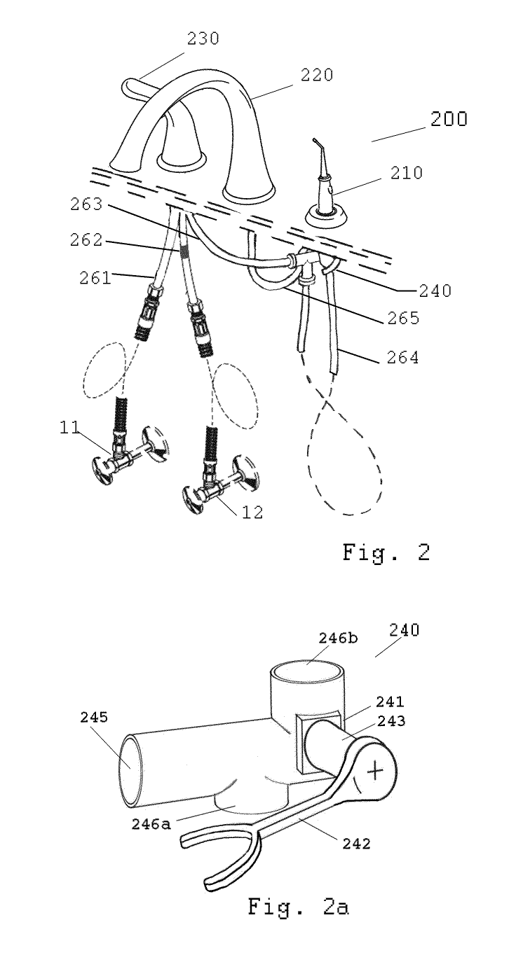

With reference to FIG. 2, a preferred build-in oral hygiene system 200 could have an automatic switcher unit. The oral hygiene system 200 generally comprised a hygiene-ware 210, a faucet 220, lever mixer valve or temperature control 230 and a switcher unit 240. Below-counter components may be a set of hot and cold water supply hoses 261 and 262, a mixed water hose 263, a hygiene-ware hose 264 and a hose to faucet 265. 11 and 12 are the hot and cold water sources. The hygiene-ware maybe configured to work in unison with an automatic switcher unit in which case the hygiene-ware can be lifted from the hygiene-ware seat which may initiate the redirection of water from faucet to the hygiene-ware. On the other hand when hygiene-ware is replaced into the seat, the flow of water may redirect from the hygiene-ware to the faucet. In either case, hygiene-ware hose 264 which is received into the hygiene-ware should be long enough to allow a user of the hygiene-ware to have freedom of activities and movement.

In FIG. 2a, an embodiment of an automatic switcher unit 240 is shown. The automatic switcher generally comprised an L-shape ball valve 241, a lever 242, a spring 243, an outlet 246a to hygiene-ware, an outlet 246b to faucet and an inlet 245. It will be recognized by one of skill in the art that the switcher unit 240 works though pressure pushing down on lever 242. The spring 243 will cause an upward bias on lever 242; however, when a hygiene-ware is in place, the hygiene-ware will create downward pressure on the lever 242. It is contemplated that removal of the hygiene-ware from its seat will allow lever 242 to move upward and the flow of water will be automatically directed away from the faucet and to the hygiene-ware. Other types of automatic switcher units may be utilize so long as they function to re-direct water flow between the faucet and the hygiene-ware.

FIG. 3 depicts series of functional headers 300 including twister 310, rotatable brush 320, gum-line brush 330, an interdental brush 340, and brush 350 etc. The functional headers can be used in build-in and portable oral hygiene system at different size and materials. The rotatable brush may not be used in the portable oral hygiene system. One of skill in the art of the functional header will appreciate that a variety of other types of functional headers maybe used so long as the functional header is capable of dispersing water.

FIG. 3a shows an exploded view of an embodiment of functional header twister 310 include the components thereof 310-315a. The functional header 310 may forms water jet beam and twister water jet and the pressurized water swirling can do deep dental cleaning even periodontal pocket.

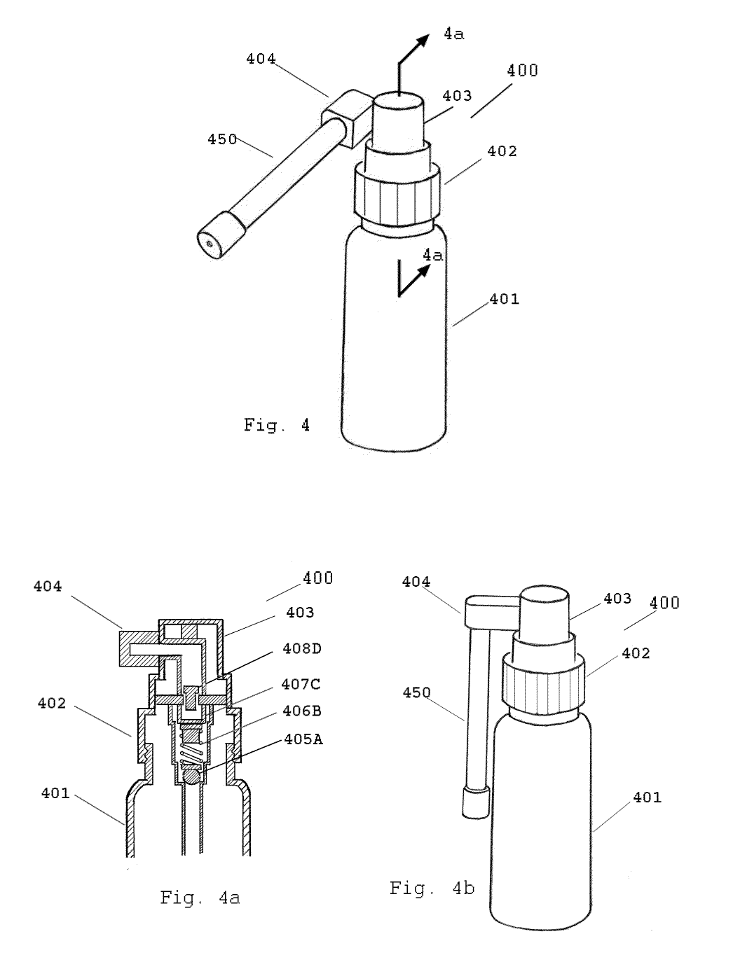

FIG. 4 depicts an embodiment of a portable oral hygiene system 400. The portable oral hygiene system 400 is sized and dimensioned to be a unitary portable device and therefore it has a relatively small receptacle 401 for holding water or other liquid. In preferred embodiments the receptacle will contain no more than 6 oz. of liquid. Receptacle 401 has a cap 402 which interacts with a depressible pump 403. FIG. 4 is the oral hygiene system 400 with the functional header 450 in a raised configuration. In the raised configuration, a channel exists between receptacle 401 and functional header 450 allowing liquid to flow from the receptacle 401 up through the pivot joint 404 and through functional header 450. Pressure may be built up by depressing pump 403 which pressure will force water jet out of the functional header. The function header 450 could be one of the functional headers 300 depicted in FIG. 3.

FIG. 4a, is across sectional view of the portable hygiene system 400. In addition, detail is shown of inlet valve 405A spring 406B, piston 407C, and outlet valve 408D. One of skill in the art will appreciate that depressing the top 403 will cause liquid to be drawn up from receptacle 401 through inlet valve 405A and up past outlet valve 408D. It is contemplated that in further embodiments means for generating pressure and sucking liquid up may also include an automated pump which may be powered by a battery.

The oral hygiene system in FIG. 4b is shown with the functional header 450 in a lowered configuration which is achieved through use of a rotatable pivot joint 404.

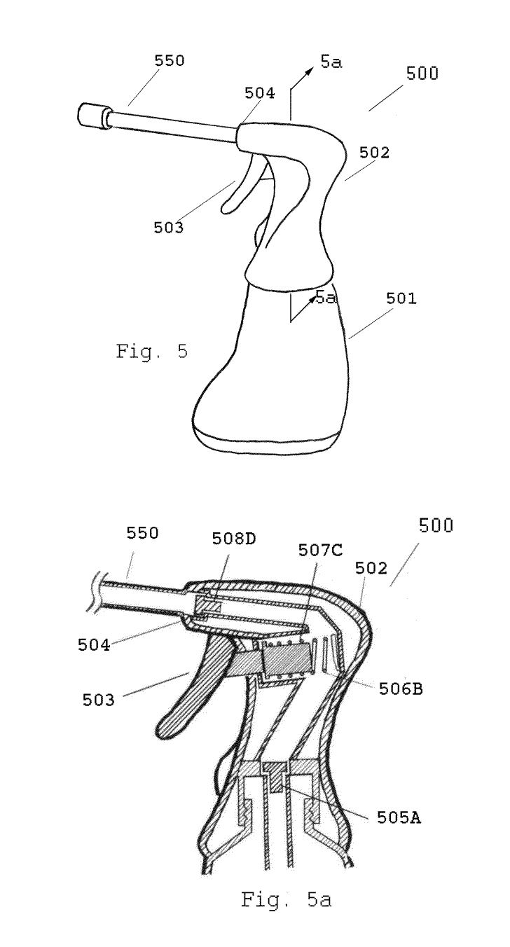

FIG. 5 is a portable oral hygiene system 500 includes a receptacle for liquid 501, cap 502, a trigger 503, a functional header connector 504, and a functional header 550. With reference to FIG. 5a, a cross section of a portable oral hygiene system 500 shows additional detail such as inlet valve 505A, spring 506B, piston 507C, and outlet valve 508D. Also, depicted in FIG. 5a are trigger 503, functional header connector 504, and cap 502. Pressure is produced by pumping trigger 503 which draws liquid up through the inlet valve 505A and out the outlet valve 508D into the functional header 550. The type of functional header will determine the type characteristics of the spray from functional headers 300 depicted in FIG. 3. It should be appreciated that one can pump the trigger in order to build up pressure and release the pressure through use of a release valve.

It is contemplated that the receptacle of the portable oral hygiene device is lightweight and may be made of a plastic, aluminum alloy or stainless steel. A receptacle will preferably be filled with an antiseptic mixture such as a mouthwash but it may be just water or may contain other ingredients which are helpful to the gums of the user.

In preferred embodiments, the oral hygiene-ware will not have a battery or other source of electrical energy and will thus be safer to use and more environmentally conscious. Moreover, the portable oral hygiene-ware may be used by people who don't otherwise have access to running water.

Thus, specific embodiments and applications of oral hygiene systems have bean disclosed. It should be apparent, however, to those skilled in the art that many more modifications beside those already described are possible without departing from the inventive concepts herein. The inventive subject matter, therefore, is not to be restricted except in the spirit of the appended claims. Moreover, in interpreting both the specification and the claims, all terms should be interpreted in the broadest manner possible consistent with the context, In particular, the terms “comprises” and “comprising” should be interpreted as referring to elements, components, or steps in a non-exclusive manner, indicating that the referenced elements, components, or steps may be present or utilized, or combined with other elements, components or steps that are not expressly referenced.

What is claimed is:

1. An oral hygiene system powered by water without the aid of electricity, comprising:
a single set of hot and cold water supply hoses coupled to a lever mixer valve that controls water temperature of water flowing to a hygiene-ware.

2. The oral hygiene system of claim 1, further comprising:
a switcher unit that controls flow to one of a faucet or the hygiene-ware.

3. The oral hygiene system of claim 2, wherein the switcher unit is automatically activated when the hygiene-ware is lifted by the user.

4. The oral hygiene system of claim 1, wherein the hygiene-ware is coupled to a sink.

5. The oral hygiene system of claim 1, wherein the hygiene-ware is coupled to a counter top.

6. The oral hygiene system of claim 1, where the hygiene-ware is sized and dimensioned to accept a functional header.

7. The oral hygiene system of claim 6, wherein the functional header forms a water jet beam.

8. The oral hygiene system of claim 6, wherein the functional header forms water jet twister and the pressurized water swirling can do deep dental cleaning even periodontal pocket.

9. The oral hygiene system of claim 6, wherein the functional header forms a brush with capable of dispersing water.

10. The oral hygiene system of claim 2, wherein the switcher unit is coupling to the faucet such that it is susceptible manual manipulation by user of the oral hygiene system.

11. A portable oral hygiene device, comprising:
a hand-hold receptacle having a means for manually generating pressure to a liquid stored in the receptacle such that the liquid is forced through a functional header at a high enough velocity to effectively clean teeth of a user.

12. The portable oral hygiene device of claim 11, wherein the means for manually generating pressure to the liquid further comprises a trigger that is susceptible to manual manipulation by the user.

13. The portable oral hygiene device of claim 11, where the receptacle is made from a light-weight plastic.

14. The portable oral hygiene device of claim 11, where the receptacle is made from a light-weight aluminum alloy.

15. The portable oral hygiene device of claim 11, where the receptacle is made from a light-weight stainless steel.

16. The oral hygiene system of claim 11, further comprising a manually operated release valve that controls release of the pressure.
